(19) United States
(12) Patent Application Publication
(10) Pub. No.: US 2025/0362732 A1
(43) Pub. Date: Nov. 27, 2025

(54) Method for operating card reader

(71) Applicant: REALTEK SEMICONDUCTOR CORPORATION, HSINCHU (TW)

(72) Inventors: JIUNN-HUNG SHIAU, HSINCHU (TW); CHENG-CHANG CHEN, HSINCHU (TW)

(21) Appl. No.: 19/175,588

(22) Filed: Apr. 10, 2025

(30) Foreign Application Priority Data
May 24, 2024 (TW) 113119355

(51) Int. Cl. G06F 1/3287; G06F 1/3212; G06F 1/3218; G06F 1/3296

(52) U.S. Cl. CPC G06F 1/3287; G06F 1/3212; G06F 1/3218; G06F 1/3296

(57) ABSTRACT

A method for operating a card reader is provided. The card reader is part of an electronic device. The method includes the following steps: executing a plurality of pieces of code or program instructions to detect a state of the electronic device; and controlling the card reader to operate in a target power-saving mode according to the state.

### BACKGROUND OF THE INVENTION

### 1. Field of the Invention

The present invention generally relates to a card reader for memory cards, and more particularly, to an operation method of the card reader.

### 2. Description of Related Art

Many handheld electronic devices (e.g., mobile phones, notebook computers, handheld game consoles, etc.) are equipped with a card reader used to read memory cards. Due to the limited power of handheld electronic devices, the power-saving capability of the card reader is one of the key factors affecting the battery life of handheld electronic devices. Achieving a balance between power saving and performance has become an important issue for a card reader.

### SUMMARY OF THE INVENTION

In view of the issues of the prior art, an object of the present invention is to provide a method for operating a card reader, so as to make an improvement to the prior art.

According to one aspect of the present invention, a method for operating a card reader is provided. The method includes the following steps: providing an application programming interface (API), which is used to control the card reader; and in response to a call to the API, controlling the card reader to operate in a target power-saving mode.

According to another aspect of the present invention, a method for operating a card reader is provided. The card reader is part of an electronic device. The method includes the following steps: determining whether an application being executed by the electronic device is in a list; and a card reader management program controls the card reader to operate or not operate in a first power-saving mode according to whether the application is in the list.

According to still another aspect of the present invention, a method for operating a card reader is provided. The card reader is a part of an electronic device. The method includes the following steps: executing a plurality of pieces of code or program instructions to detect a state of the electronic device; and controlling the card reader to operate in a target power-saving mode according to the state.

According to still another aspect of the present invention, a method for operating a card reader is provided. The card reader is connected to a memory card. The method includes the following steps: establishing a model based on a history of accesses to the memory card; and controlling the card reader to operate in a target power-saving mode based on the model.

The technical means embodied in the embodiments of the present invention can solve at least one of the problems of the prior art. Therefore, compared to the prior art, the present invention helps the card reader achieve a better balance between power saving and performance.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 is a functional block diagram of an electronic device according to an embodiment of the present invention.

FIG. 2 is a flowchart of the operation method of the card reader according to an embodiment of the present invention.

FIG. 3 is a flowchart of switching the operation mode of a card reader according to an embodiment of the present invention.

FIG. 4 is a flowchart of the operation method of the card reader according to another embodiment of the present invention.

FIG. 5 is a flowchart of the operation method of the card reader according to another embodiment of the present invention.

FIG. 6 is a flowchart of the operation method of the card reader according to another embodiment of the present invention.

FIG. 7 is a flowchart of the operation method of the card reader according to another embodiment of the present invention.

FIG. 8 is a flowchart of the operation method of the card reader according to another embodiment of the present invention.

FIG. 9 is a flowchart of the operation method of the card reader according to another embodiment of the present invention.

FIG. 10 is a flowchart of the operation method of the card reader according to another embodiment of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes a method for operating a card reader. On account of that some or all elements of the electronic device could be known, the detail of such elements is omitted provided that such detail has little to do with the features of this disclosure, and that this omission nowhere dissatisfies the specification and enablement requirements. Some or all of the processes of the method for operating a card reader may be implemented by software and/or firmware and can be performed by the electronic device or its equivalent. A person having ordinary skill in the art can choose components or steps equivalent to those described in this specification to carry out the present invention, which means that the scope of this invention is not limited to the embodiments in the specification.

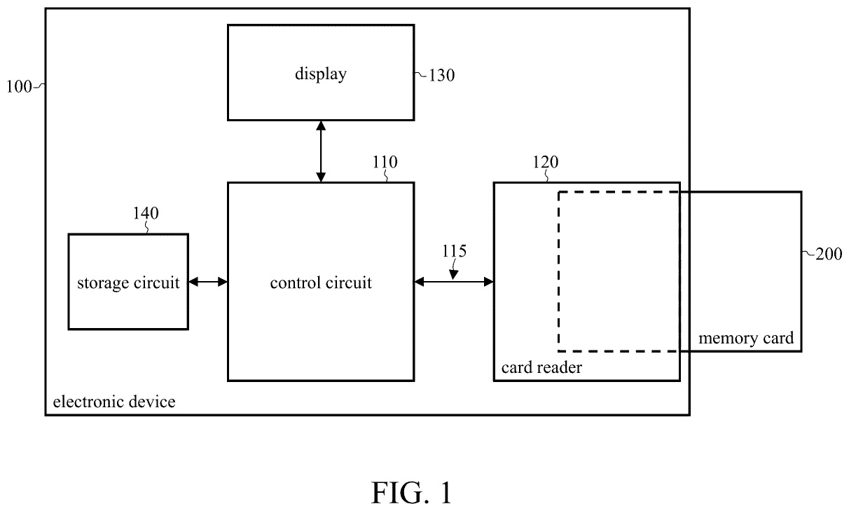

Reference is made to FIG. 1, which is a functional block diagram of the electronic device according to an embodiment of the present invention. The electronic device 100 includes a control circuit 110, a card reader 120, a display 130, and a storage circuit 140. The card reader 120 is connected to the memory card 200. The memory card 200 is not a part of the electronic device 100. The control circuit 110 of the electronic device 100 accesses the memory card 200 through the card reader 120. The storage circuit 140 stores the program code or program instructions of the electronic device 100 (e.g., the operating system, applications, and/or drivers). In addition to executing the operating system and applications of the electronic device 100, the control circuit 110 also executes the card reader driver of the card reader 120.

In some embodiments, the memory card 200 is a Secure Digital (SD) card, and the connection 115 between the control circuit 110 and the card reader 120 is based on the universal serial bus (USB) protocol or the Peripheral Component Interconnect Express (PCI-Express, abbreviated as PCIe) protocol.

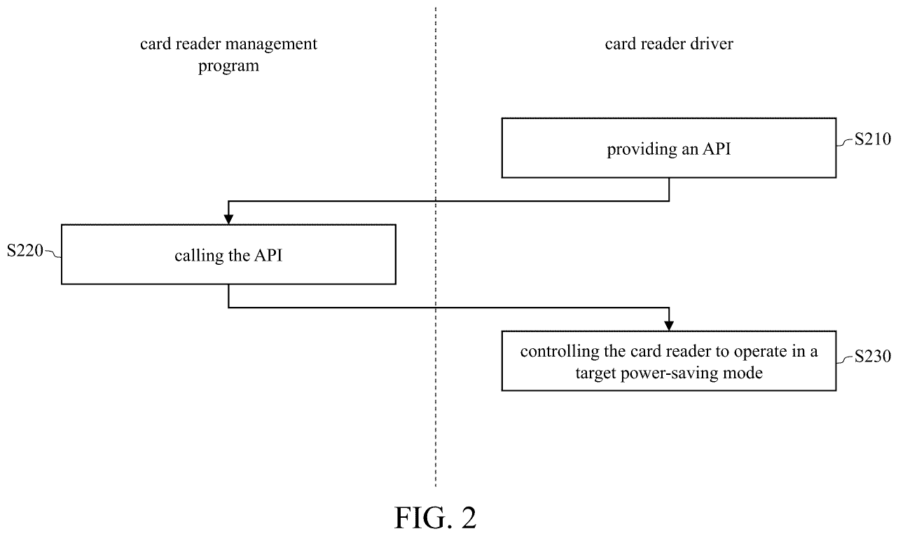

Reference is made to FIG. 2, which is a flowchart of the operation method of the card reader according to an embodiment of the present invention. The card reader management program is one of the applications of the electronic device 100 and is configured to manage the card reader 120. The card reader driver provides an application programming interface (API) (step S210). The card reader management program calls the API (step S220), and then the card reader driver responds to the card reader management program's call to the API, controlling the card reader 120 to operate in a target power-saving mode (step S230). For example, when a user of the electronic device 100 wants to reduce the power consumption of the electronic device 100, the user can control the card reader 120 to enter a high power-saving mode through the card reader management program and the API.

It should be noted that, in some embodiments, the card reader 120 has more than one power-saving mode, such as a 25% power-saving mode, a 50% power-saving mode, and a 75% power-saving mode, where the 25% power-saving mode can be regarded as a low power-saving mode, while the 75% power-saving mode can be regarded as a high power-saving mode. For example, in the high power-saving mode, a relatively large number of functions of the card reader 120 are turned off, and thus, the card reader 120 consumes less power; in the low power-saving mode, the card reader 120 has relatively few functions turned off and consumes more power. Generally speaking, when the card reader 120 operates in the high power-saving mode, the performance of the card reader 120 is poorer (e.g., longer delay), and when the card reader 120 operates in the low power-saving mode, the performance of the card reader 120 is better (e.g., shorter delay).

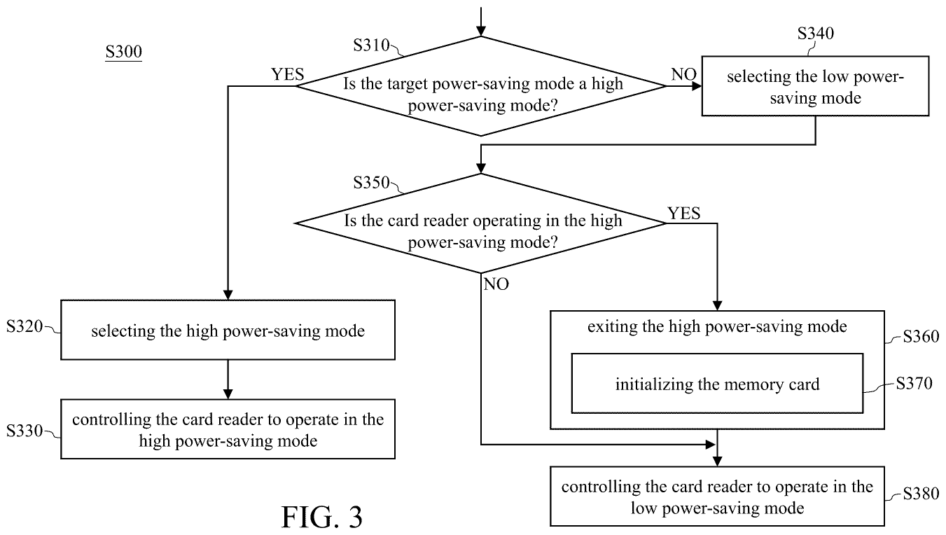

Reference is made to FIG. 3, which is a flowchart of switching the operation mode of a card reader according to an embodiment of the present invention. The operational details of step S230 are as shown in the operation mode switching process S300. The operation mode switching process S300 is a part of the card reader driver, including the following steps.
Step S310: Determining whether the target power-saving mode is a high power-saving mode. If YES, then the flow proceeds to step S320; otherwise, the flow proceeds to step S340.
Step S320: Selecting the high power-saving mode as the mode in which the card reader 120 is about to operate.
Step S330: Controlling the card reader 120 to operate in the high power-saving mode.
Step S340: Selecting the low power-saving mode as the mode in which the card reader 120 is about to operate.
Step S350: Determining whether the card reader 120 is operating in the high power-saving mode. If YES, then the flow proceeds to step S360; otherwise, the flow proceeds to step S380.
Step S360: Controlling the card reader 120 to exit the high power-saving mode, with details including the initialization of the memory card 200 (Step S370).
Step S380: Controlling the card reader 120 to operate in the low power-saving mode (i.e., controlling the card reader 120 to enter the low power-saving mode).

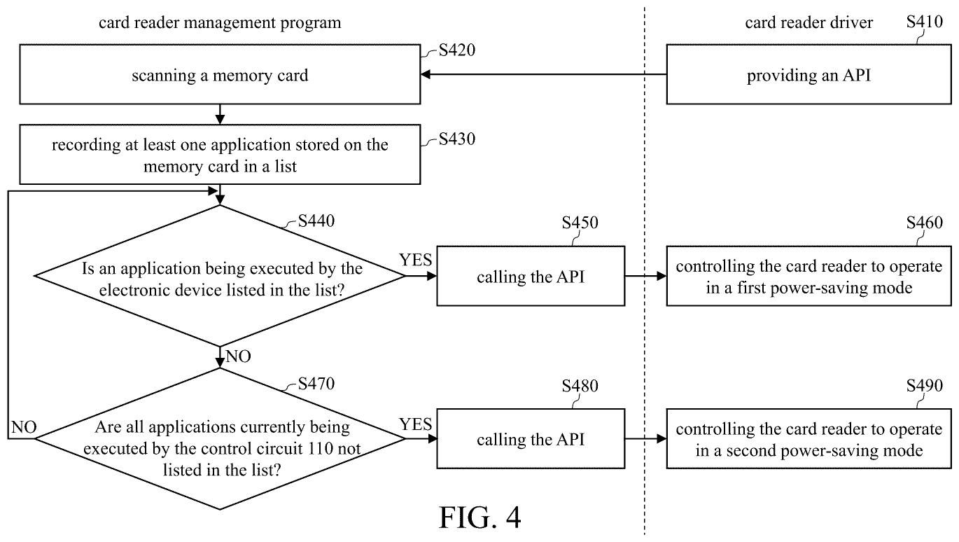

Reference is made to FIG. 4, which is a flowchart of the operation method of the card reader according to another embodiment of the present invention. The flowchart includes the following steps.
Step S410: The card reader driver provides an API.
Step S420: The card reader management program scans the memory card 200.
Step S430: The card reader management program records at least one application stored on the memory card 200 in a list. The list can be stored in the storage circuit 140.

In some embodiments, the list is a whitelist. That is to say, when the control circuit 110 is executing any application in the list, the control circuit 110 (more specifically, the card reader management program) controls the card reader 120 to enter a first power-saving mode (e.g., the low power-saving mode), and when the control circuit 110 is not executing any application in the list, the control circuit 110 (more specifically, the card reader management program) controls the card reader 120 to enter a second power-saving mode (e.g., the high power-saving mode).
Step S440: The card reader driver determines whether an application being executed by the electronic device 100 (more specifically, the control circuit 110) is in the list. If YES (i.e., the control circuit 110 is executing at least one application in the list), then the flow proceeds to step S450; otherwise, the flow proceeds to step S470.
Step S450: The card reader management program calls the API.
Step S460: The card reader driver controls the card reader 120 to operate in a first power-saving mode (e.g., the low power-saving mode).
Step S470: The card reader management program determines whether all applications currently being executed by the control circuit 110 are not in the list. If YES (i.e., the control circuit 110 is not executing any application in the list), then the flow proceeds to step S480; otherwise, the flow returns to step S440.
Step S480: The card reader management program calls the API.
Step S490: The card reader driver controls the card reader 120 to operate in a second power-saving mode (e.g., the high power-saving mode).

It should be noted that, in other embodiments, the step S420 can be omitted, and instead, the list in the step S430 is generated manually. For example, the list is provided by a user of the electronic device 100, a manufacturer of the card reader 120, or a manufacturer of the electronic device 100.

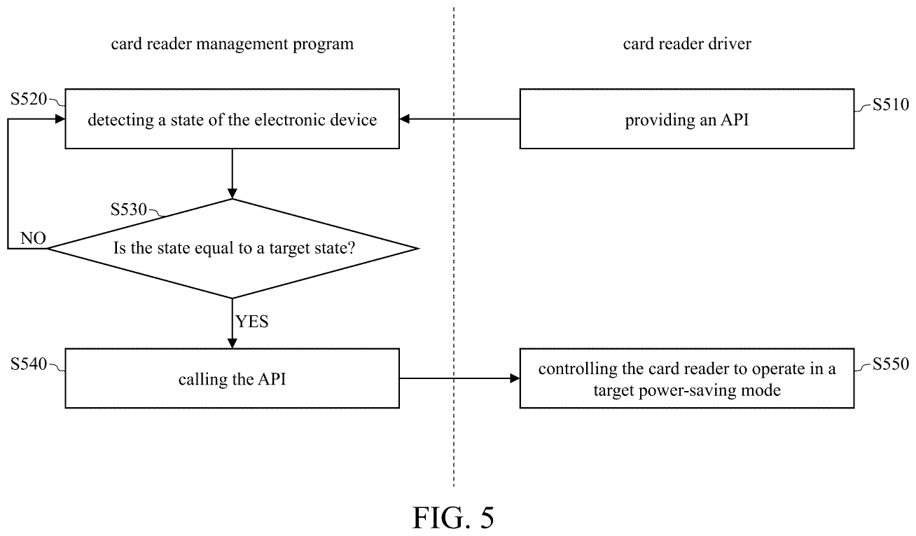

Reference is made to FIG. 5, which is a flowchart of the operation method of the card reader according to another embodiment of the present invention. The flowchart includes the following steps.
Step S510: The card reader driver provides an API.
Step S520: The card reader management program detects a state of the electronic device 100. For example, the state includes but is not limited to the display 130 being on/off, the electronic device 100 being logged in/out, and/or the power level of the electronic device 100. In some embodiments, the card reader management program can implement step S520 through an API provided by the operating system of the electronic device 100.
Step S530: The card reader management program determines whether the state is equal to a target state. If YES, then the flow proceeds to step S540; otherwise, the flow returns to step S520.
Step S540: The card reader management program calls the API.
Step S550: The card reader driver controls the card reader 120 to operate in a target power-saving mode.

For example, when the target state is the display 130 being on (indicating that the user may be using the electronic device 100), the target power-saving mode is the low power-saving mode. When the target state is the display 130 being off (indicating that the user may not be using the electronic device 100), the target power-saving mode is the high power-saving mode.

For another example, when the target state is that the electronic device 100 has been logged in (indicating that the user may be using the electronic device 100), the target power-saving mode is the low power-saving mode. When the target state is that the electronic device 100 has been logged out (or has not been logged in) (indicating that the user may not be using the electronic device 100), the target power-saving mode is the high power-saving mode.

For another example, when the target state is that the electronic device 100 has sufficient power (e.g., the power level is greater than a threshold value or the electronic device 100 is connected to a power source), the target power-saving mode is the low power-saving mode. When the target state is that the electronic device 100 has insufficient power (e.g., the power level is less than or equal to the threshold value or the electronic device 100 is not connected to a power source), the target power-saving mode is the high power-saving mode.

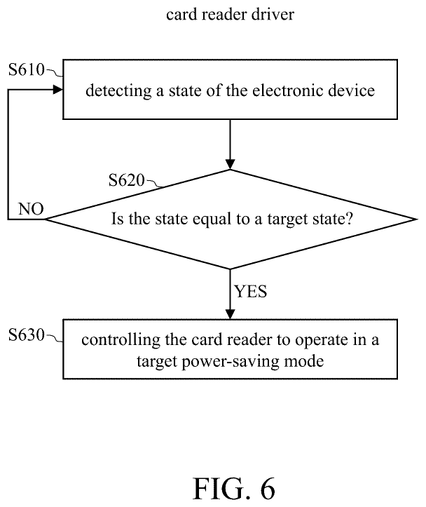

Reference is made to FIG. 6, which is a flowchart of the operation method of the card reader according to another embodiment of the present invention. FIG. 6 is similar to FIG. 5 (with step S610, step S620, and step S630 being respectively equal to step S520, step S530, and step S550), except that step S610, step S620, and step S630 are all executed by a card reader driver. In some embodiments, the operating system of the electronic device 100 provides the card reader driver with an API for querying the state of the electronic device 100 (e.g., whether the display 130 is on/off, whether the electronic device 100 has been logged in/out, the power level of the electronic device 100, and/or whether the electronic device 100 is charging).

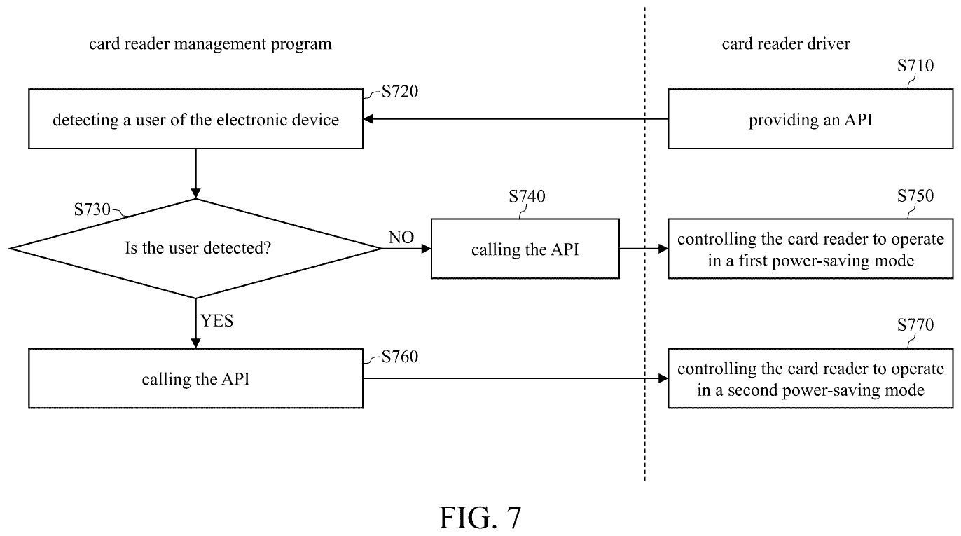

Reference is made to FIG. 7, which is a flowchart of the operation method of the card reader according to another embodiment of the present invention. The flowchart includes the following steps.
Step S710: The card reader driver provides an API.
Step S720: The card reader management program detects a user of the electronic device 100. For example, the card reader management program can detect the user based on the image or sound of the user.
Step S730: The card reader management program determines whether the user is detected. When the user is detected, it is likely that the user is using the electronic device 100.
Step S740: The card reader management program calls the API.
Step S750: The card reader driver controls the card reader 120 to operate in a first power-saving mode (e.g., the high power-saving mode).
Step S760: The card reader management program calls the API.
Step S770: The card reader driver controls the card reader 120 to operate in a second power-saving mode (e.g., the low power-saving mode).

It should be noted that, in other embodiments, the control circuit 110 can determine the target power-saving mode based on multiple states of the electronic device 100 simultaneously, including whether a user is detected.

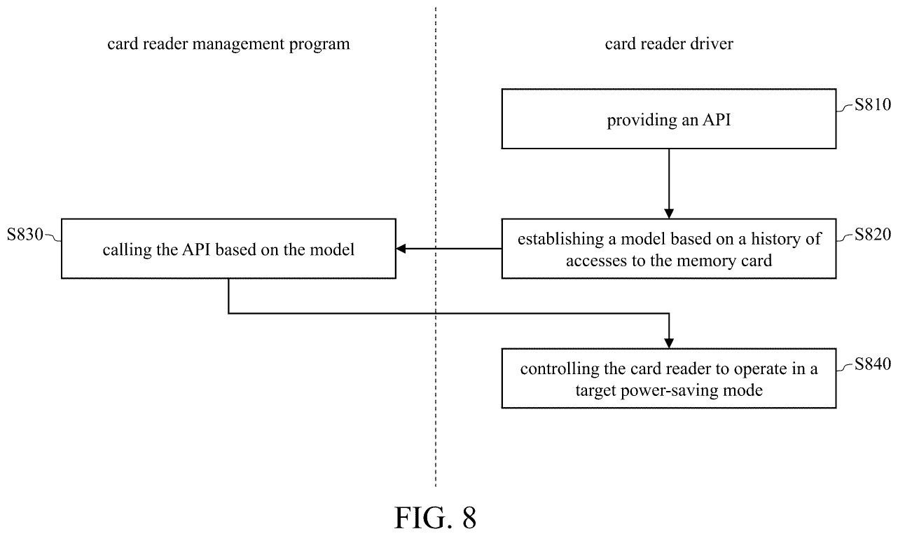

Reference is made to FIG. 8, which is a flowchart of the operation method of the card reader according to another embodiment of the present invention. The flowchart includes the following steps.
Step S810: The card reader driver provides an API.
Step S820: The card reader driver establishes a model based on a history of accesses to the memory card 200. For example, the card reader driver can establish the model based on the frequency of access to the memory card 200 and/or the time period during which the memory card 200 is accessed.
Step S830: The card reader management program calls the API based on the model. For example, when the card reader management program determines that the current time falls within the time period recorded by the model (indicating that the user may be about to access the memory card 200), the card reader management program calls the API.
Step S840: The card reader driver controls the card reader 120 to operate in a target power-saving mode (e.g., the low power-saving mode or the high power-saving mode).

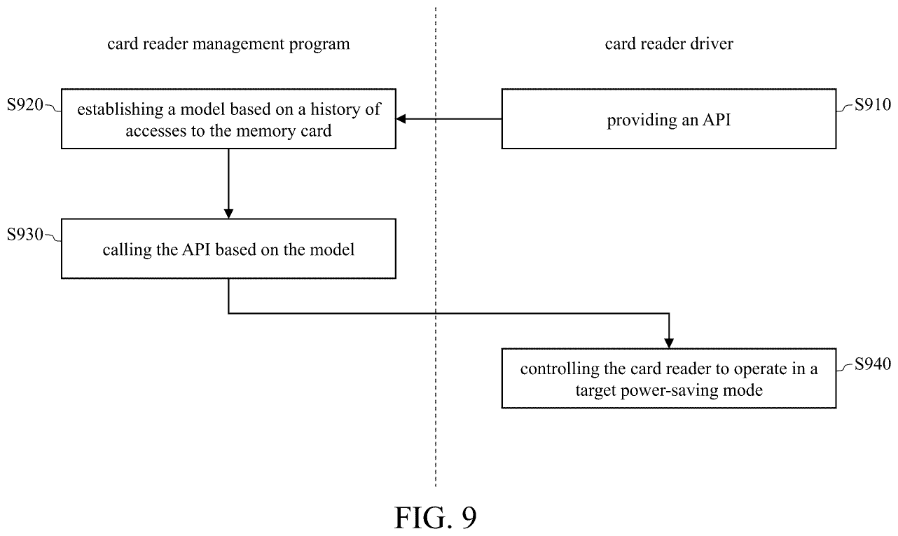

Reference is made to FIG. 9, which is a flowchart of the operation method of the card reader according to another embodiment of the present invention. FIG. 9 is similar to FIG. 8 (steps S910 to S940 are respectively equal to steps S810 to S840), except that step S920 is executed by a card reader management program.

The operational details of steps S460, S490, S550, S630, S750, S770, S840, and S940 can be as shown in the operation mode switching process S300 of FIG. 3, wherein for steps S460, S490, S750, and S770, the target power-saving mode in step S310 is the first power-saving mode or the second power-saving mode.

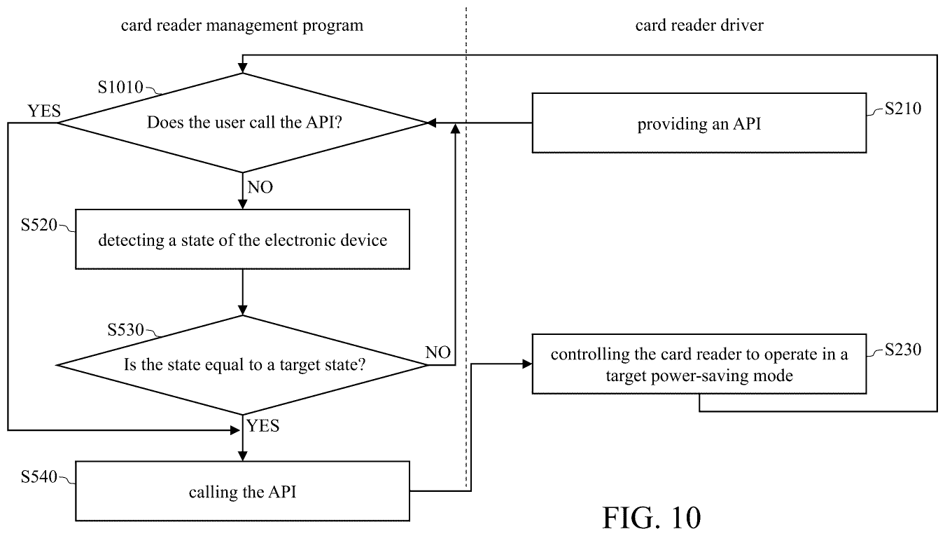

The above embodiments can be combined. For example, the embodiment of FIG. 2 can be combined with the embodiment of FIG. 5 to form the operation method of the card reader in FIG. 10. Steps S210 and S230 in FIG. 10 are the same as those in FIG. 2, while steps S520 to S540 are the same as those in FIG. 5. If the user calls the API through the card reader management program (the result of step S1010 is YES), then the card reader management program performs step S540; otherwise, the card reader management program performs step S520 to detect a state of the electronic device 100. If the state is equal to a target state (the result of step S530 is YES), then the card reader management program performs step S540; otherwise, the card reader management program performs step S1010.

The SD cards are intended to illustrate the invention by way of example and not to limit the scope of the claimed invention. People having ordinary skill in the art may apply the present invention to other types of memory cards in accordance with the foregoing discussions.

Note that the shape, size, and ratio of any element in the disclosed figures are exemplary for understanding, not for limiting the scope of this invention. Furthermore, there is no step sequence limitation for the method inventions as long as the execution of each step is applicable. In some instances, the steps can be performed simultaneously or partially simultaneously.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A method for operating a card reader, comprising:
providing an application programming interface (API) that is configured to control the card reader; and
in response to a call to the API, controlling the card reader to operate in a target power-saving mode.

2. The method of claim 1, wherein the target power-saving mode is a low power-saving mode, the card reader operates in a high power-saving mode before entering the low power-saving mode, the card reader is connected to a memory card, and the method further comprises:
before entering the low power-saving mode, first exiting the high power-saving mode and then initializing the memory card.

3. The method of claim 1, wherein the card reader is a part of an electronic device, and the method further comprises:
detecting a state of the electronic device; and
controlling the card reader, according to the state, to operate or not operate in the target power-saving mode.

4. The method of claim 3, wherein the step of detecting the state of the electronic device is performed by a card reader management program of the electronic device, and the method further comprises:
when the state is a target state, the card reader management program calls the API to control the card reader to operate in the target power-saving mode.

5. The method of claim 4, wherein the target state is a display of the electronic device being off, and the target power-saving mode is a high power-saving mode.

6. The method of claim 4, wherein the target state is the electronic device being logged in, and the target power-saving mode is a low power-saving mode.

7. The method of claim 4, wherein the target state is that a power level of the electronic device is greater than a threshold value or the electronic device is connected to a power source, and the target power-saving mode is a low power-saving mode.

8. The method of claim 1, wherein the card reader is a part of an electronic device, and the method further comprises:
detecting a user of the electronic device; and
controlling the card reader to operate in a low power-saving mode when the user is detected.

9. A method for operating a card reader, wherein the card reader is a part of an electronic device, and the method comprises:
determining whether an application being executed by the electronic device is in a list; and
a card reader management program controls the card reader to operate or not operate in a first power-saving mode according to whether the application is in the list.

10. The method of claim 9 further comprising:
controlling the card reader to operate in the first power-saving mode when the application is in the list;
wherein the first power-saving mode is a low power-saving mode.

11. The method of claim 10, wherein the card reader operates in a high power-saving mode before entering the low power-saving mode, the card reader is connected to a memory card, and the method further comprises:
before entering the low power-saving mode, first exiting the high power-saving mode and then initializing the memory card.

12. The method of claim 9 further comprising:
controlling the card reader to operate in a second power-saving mode when all applications being executed by the electronic device are not in the list;
wherein the first power-saving mode is a low power-saving mode, and the second power-saving mode is a high power-saving mode.

13. The method of claim 9, wherein the card reader is connected to a memory card, and the method further comprises:
scanning the memory card; and
recording at least one application stored on the memory card in the list.

14. A method for operating a card reader, wherein the card reader is a part of an electronic device, and the method comprises:
executing a plurality of pieces of code or program instructions to detect a state of the electronic device; and
controlling the card reader to operate in a target power-saving mode according to the state.

15. The method of claim 14, wherein the step of detecting the state of the electronic device is performed by a card reader management program of the electronic device, and the method further comprises:
providing an application programming interface (API) that is configured to control the card reader; and
when the state is a target state, the card reader management program calls the API to control the card reader to operate in the target power-saving mode.

16. The method of claim 15, wherein the target state is a display of the electronic device being off, and the target power-saving mode is a high power-saving mode.

17. The method of claim 15, wherein the target state is the electronic device being logged in, and the target power-saving mode is a low power-saving mode.

18. The method of claim 15, wherein the target state is that a power level of the electronic device is greater than a threshold value or the electronic device is connected to a power source, and the target power-saving mode is a low power-saving mode.

19. The method of claim 14 further comprising:
detecting a user of the electronic device; and
controlling the card reader to operate in a low power-saving mode when the user is detected.
